(19) United States
(12) Patent Application Publication
(10) Pub. No.: US 2005/0200479 A1
(43) Pub. Date: Sep. 15, 2005

(54) Vehicle automatic emergency response system

(76) Inventor: Campbell Richard James, Victoria (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/506,400

(22) PCT Filed: Mar. 17, 2003
(86) PCT No.: PCT/AU03/00316

§ 371 Date: May 19, 2005

(30) Foreign Application Priority Data
Mar. 15, 2002 (AU) PS 1232

(51) Int. Cl. G08B 1/08

(52) U.S. Cl. 340/539.18; 340/988; 340/426.19; 379/45; 455/404.1

(57) ABSTRACT

An automatic emergency response system is operable to notify an emergency center of a defined event, such as a vehicle accident. The system facilitates location of the event, by using position determining means, such as GSP, to establish its at least approximate location. A control circuit includes code generating means to generate a coded signal incorporating the position location information. An alarm signal transmitter is operable on occurrence of the defined event to transmit an alarm signal incorporating the coded signal to a receiving station, which may be a satellite, which relays the message to the emergency center, including the positional information relating to the location of the transmitter. A relative low power homing signal transmitter simultaneously transmits a homing signal either continuously or at periodic intervals.

### FIELD OF THE INVENTION

This invention relates to a vehicle automatic emergency response system and relates particularly to such a system able to be used to identify and locate a vehicle on the occurrence of a defined event, such as an accident involving that vehicle.

Although the invention will be described with particular reference to its use in relation to motor vehicles, it will be apparent that the invention has application to boats and even aircraft, hang gliders, ultra-light aircraft vehicles and the like.

### BACKGROUND OF THE INVENTION

Forms of vehicle emergency response systems have been previously proposed. In one proposal, an emergency response system requires the use of a mobile phone network in conjunction with GPS or possibly mobile phone network cell based positioning. A deficiency of such a system is that it is impractical to provide coverage in remote areas or areas where the mobile phone network has minimal coverage. Such a system, therefore, would be unable to be used in those areas which are relatively high accident areas and which are most in need of an appropriate emergency response system.

It has been proposed to use the satellite telephone network and to provide appropriate telephone transmitters within vehicles. However, satellite telephones tend to be rather large, heavy, expensive and require a subscription with associated cost.

U.S. Pat. No. 5,554,993 proposes a global positioning determining system for use as a search and rescue system. This patent discloses the use of a system wherein a user initiates transmission of a positioning signal to initiate a search mission. Such a signal causes the initiation of a search and rescue operation in which a mobile homing terminal carried by rescue personnel approaches a position provided by the initial signal. The mobile homing terminal then transmits an activating signal which is received by the user terminal and causes the user terminal to transmit a continuous homing signal. The homing terminal can then move towards and locate the homing beacon.

This system, however, requires that the user terminal has both transmit and receive capabilities thereby increasing the cost of the user terminal. Further, as the continuous wave homing beacon signal transmits only after initiation, it is therefore reliant on reception of the initiation signal and proper actuation of the transmitter responding thereto. This adds a level of complication to the user terminal. Still further, the mobile terminal may be out of range when sending an initiation signal and, particularly if more than one mobile terminal is used in a search and rescue mission, a failure to activate the beacon may result in confusion as to its actual location.

U.S. Pat. No. 5,808,564 discloses a fully automatic personal security system which includes a mobile unit, which may be mounted in a vehicle or the like, and one or more personal, portable actuation units. The mobile unit has a programmable memory containing identity information, a dedicated receiver for receiving an alarm condition signal from the portable unit, a position locater providing position co-ordinates to indicate the location of the mobile entity and communication means, such as a cellular phone adapted to be connected to a central dispatch station. An alarm condition can be initiated by manual actuation or by remote sensors detecting predetermined vehicle conditions, such as air bag actuation. The mobile unit includes a receiver to receive signals from the central controller and which may be used to activate selected relays in the vehicle to trigger headlight flashing, the vehicle horn or the like to assist locating the mobile unit.

While the system is multi-functional, it is also very complicated, of relatively large size and expensive to produce. The system requires by directional communication which requires substantial electrical power reserves thus relying on a vehicle battery or power system. Thus, in the event of a vehicle accident in which the vehicle battery is dislodged or disconnected or otherwise rendered inoperable, the system of this patent would be inoperative.

U.S. Pat. No. 5,367,306 discloses method and apparatus for integration of an emergency locater transmitter (ELT) radio beacon signal with a global positioning system (GPS). In the event of an accident, the ELT is activated to periodically or continuously broadcast a radio beacon signal which contains the GPS information. This system, however, specifically designed for aircraft and the continually transmitted radio beacon signal is of a strength to communicate with orbiting satellites or other aircraft.

U.S. Pat. No. 6,324,393 B1 discloses an automatic emergency rescue transmitter which, in the event of a vehicle accident, transmits an alarm message which is able to be picked up by any AM broadcast receiver within range of several miles. However, this invention relies on a message being received by a radio receiver in the vicinity of the accident.

### SUMMARY OF THE INVENTION

It is therefore desirable to provide an improved form of automatic emergency response system that alleviates disadvantages of previously proposed systems.

It is also desirable to provide a system that is economical and simple to manufacture and install in vehicles or in other applications.

It is also desirable to provide a vehicle automatic emergency response system which facilitates the identification of a predefined event and which incorporates means for facilitating physical location of a vehicle or the like.

According to one aspect of the present invention there is provided an automatic emergency response system operable to notify an emergency centre of a defined event and to facilitate location of the event, the system including signal generating means to generate a signal incorporating information which enables location of the signal to be established, an alarm signal transmitter operable on occurrence of a defined event to transmit an alarm signal incorporating said signal to a receiving station which provides the emergency centre with information relating to the signal transmission, position determining means to establish its at least approximate location, a homing signal transmitter which simultaneously transmits a homing signal either continuously or at periodic intervals, and actuating means to initiate the alarm transmitter and homing signal transmitter, the actuating means being initiated by any of the defined events.

The system of the invention is particularly adapted for use with motor vehicles. In one particular form of the invention, the alarm signal transmitter and homing signal transmitter are mounted within a motor vehicle together with position determining means, such as a GPS unit. In this embodiment, the actuating means may include an accelerometer or other detector for detecting a vehicle impact or collision or which is used to activate a vehicle air bag. When such an event triggers the actuating means, the alarm signal transmitter transmits a packet of information which includes a request for assistance together with information concerning the last known position of the vehicle as determined from the associated GPS unit. Other data may be included in the packet of information, such as vehicle and accident description and apparent crash severity, as can be determined from the sensors in the vehicle, the number of air bags deployed, rate of change in speed and direction, the number of vehicle occupants, if known, and any other relevant information. Such signal transmission may be repeated continuously or at predetermined intervals, depending on the status of a power supply.

Simultaneously, a periodic or continuous homing beacon signal is transmitted by a radio beacon to facilitate manual location of the transmitter. The radio beacon may also include GPS data, if known, or other coding that may assist in locating the vehicle either from the air or the ground. However, it is an important feature of the invention that the beacon transmission is carried out in a way as to maximise battery life of the battery used to power the radio beacon.

The system may be powered from either the battery of the vehicle in which the system is located or from its own self-contained battery. Preferably, the vehicle battery is used to provide the power for the transmitters unless or until that supply is severed or exhausted at which time the self-contained, in-built battery provides the necessary power. In the case that the system is using the in-built battery, transmissions of the alarm signal transmitter may be reduced or minimised.

According to a further aspect of the invention there is provided an automatic emergency response system operable to notify an emergency centre of a defined event and to facilitate location of the event, the system including position determining means to establish its at least approximate location, code generating means to generate a coded signal incorporating position location information, an alarm signal transmitter operable on occurrence of a defined event to transmit an alarm signal incorporating said coded signal to a receiving station which provides the emergency centre with information relating to the signal transmission, including the positional information relating to the location of the transmitter, a relative low power homing signal transmitter which simultaneously transmits a homing signal either continuously or at periodic intervals, and actuating means to initiate the alarm transmitter and homing signal transmitter, the actuating means being initiated by any of the defined events.

It is preferred that, in this aspect, the signal generating means generates a coded signal to be transmitted by the alarm signal transmitter.

Preferably, the system includes position determining means which establishes through electromagnetic radiation transmissions the at least approximate location of the position determining means. This may be carried out by satellites programmed to be able to detect the homing signals transmitted by the homing signal transmitter and to provide a relatively exact location of the transmitter.

Alternatively, position determining means, such as a GPS unit, is operatively associated with the alarm signal transmitter whereby position information is periodically provided to the transmitter, such as at one second intervals. However, the invention may also incorporate position determining means using cellular mobile telephone networks to determine a vehicle position.

The alarm signal transmitter and homing signal transmitter may be a single transmitter unit switched between operational modes as required. Alternatively, separate transmitters may be used for the different signal transmissions.

The homing signal transmitter may comprise or include a bright pulsing light or other periodic light source or sound source to attract attention to the transmitter location.

In another embodiment of the invention, the system may interface to a mobile telephone system. Assuming a vehicle in which the system is mounted is no longer moving after an accident, it may be sufficient that either GPS information or mobile cellular telephone system positioning information is fed continuously to the transmitter and that it will transmit with the last known established position from the external system. Further, if a communication system can establish a telephone link with a mobile telephone network, a request for assistance may be directed via that service rather than through a satellite emergency network service which would otherwise constitute the receiving station.

### DESCRIPTION OF THE DRAWINGS

In order that the invention is more readily understood, one embodiment thereof will now be described with reference to the accompanying drawings wherein:

FIG. 1 illustrates an automatic emergency response system in accordance with an embodiment of the invention;

FIG. 2 schematically illustrates the operation of the system, and

FIG. 3 is a block diagram of the system of this embodiment.

### DESCRIPTION OF PREFERRED EMBODIMENT

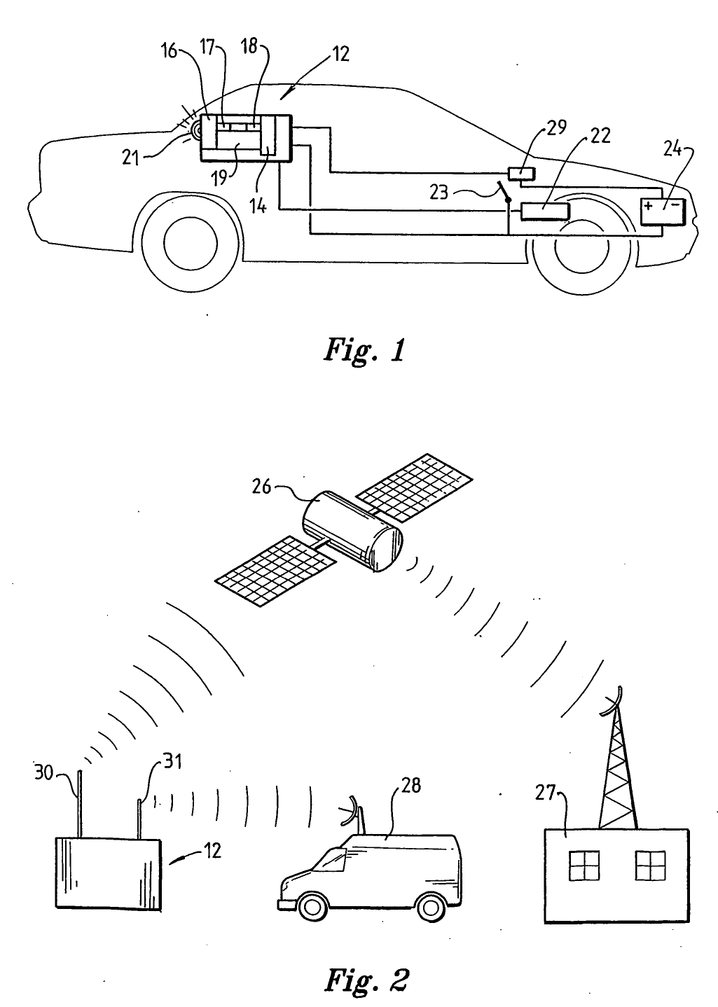

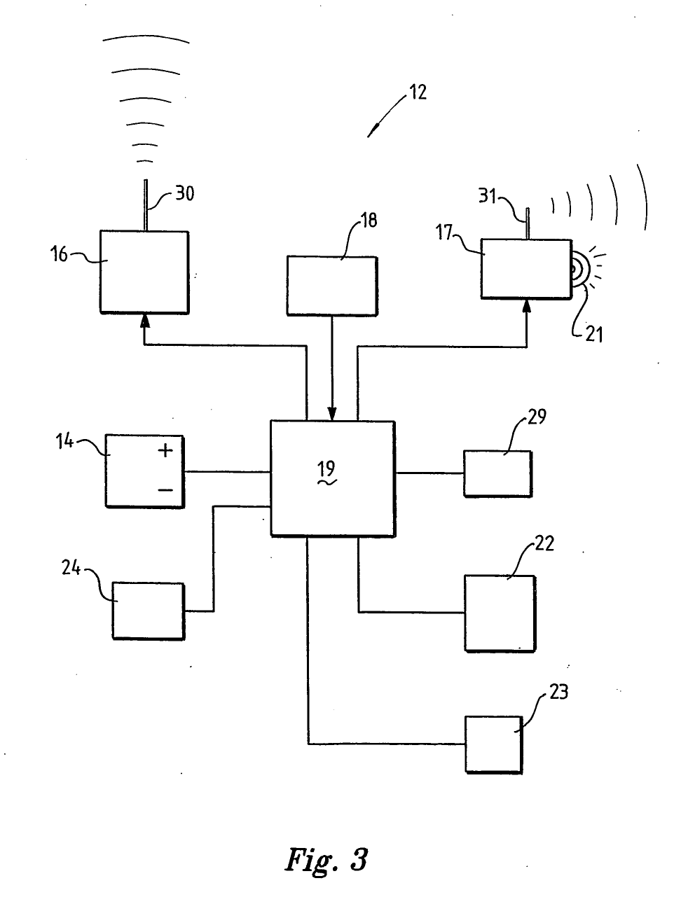

Referring to the drawings, FIGS. 1 to 3 schematic illustrate an embodiment of the invention installed in a motor vehicle. The system 12 is preferably mounted in a relatively protected area of the vehicle, such as beneath a rear parcel shelf or adjacent a forward crash pad. The system 12 incorporates the in-vehicle components shown more particularly in the block diagram of FIG. 3, and includes an in-built power supply battery 14, an alarm signal transmitter 16, a radio beacon transmitter 17, a GPS unit 18 and control circuitry 19. The system of this embodiment may also include a strobe lamp 21 for producing light pulses.

The vehicle in which the system is installed includes an accelerometer 22 which is used to initiate operation of the vehicle air bag system in response to an accident or impact. Although only one accelerometer 22 is illustrated, it will be understood that vehicles in which the system is installed may have any number of accelerometers for a plurality of air bags throughout the vehicle. The system of the invention may be operatively associated with any one or selected ones of the accelerators or sensors on the vehicle which will give rise to a defined event initiating operation of the system of the invention. Such a defined event may include a collision or impact, a roll over, or theft of the vehicle. In the latter case, theft of the vehicle may be indicated by sensors actuated by tampering, or by movement sensors when an alarm has been set.

A manual switch 23 may also be employed in the vehicle to enable manual actuation of the system in the event of, for example, attempting car jacking or the like. Other actuating modes may be incorporated in the system to account for differing circumstances associated with vehicle operation and different types of vehicles, such as motor cycles, boats and the like.

The control circuitry 19 generates an encoded signal for transmission by the alarm signal transmitter 16 and generates periodic signals for transmission by the radio beacon transmitter 17. The transmitters 16 and 17 include integral antenna to avoid risk of damage or separation in the event of an impact or accident. However, the transmitters may also be arranged to utilise one or more external antenna 30 and 31.

While the system has its own in-built battery 14, it is designed to utilise the power of the vehicle batter 24 unless that battery is disconnected or exhausted, at which time the in-built battery will be switched to provide power for the transmitters 16 and 17.

The internal battery 14 preferably is maintained in a fully charged condition from the vehicle battery 24 or vehicle alternator (not shown) through the control circuitry 19.

In the event of an accident or the occurrence of a defined event, or actuation of the manual switch 23, the control circuit generates an encoded signal incorporating positional data from the GPS unit 18 as well as other information including vehicle identification, time, vehicle passenger numbers, apparent crash severity, rate of changes in speed and direction, and other information which may be of use to assist the vehicle occupants. The generated encoded signal is transmitted by the alarm signal transmitter 16 to a receiving station 26. In one form of the invention, the receiving station is a low orbit satellite used by emergency services and similar organisations. Such a receiving station receives the coded transmission and either relays the transmission to an emergency service network centre 27 or transmits a corresponding signal containing the coded information. In another form of the invention, the receiving station is a ground station, or an aircraft. On receipt of an alarm signal from a receiving station 26, the emergency centre initiates a search and rescue operation having positional information on which to base a search strategy. Consequently, a search party 28 is able to approach the location relatively quickly, and when within range of the radio beacon transmitted signal, they can home in on that signal and on the transmitter even though the vehicle in which the transmitter is located may be buried in snow or hidden in undergrowth or dense bush or the like.

Actuation of the system may also initiate operation of a strobe lamp 21, the operation of which may be subject to the availability of suitable power from the vehicle battery 24.

To reduce the incidents of accidental triggering of the system, it may be connected through the vehicle ignition circuit 29, and the control circuitry 19 may monitor the ignition so as not to activate the system unless the ignition is “on” or has been off for a predetermined period of time only. The manual switch 23 may also be operable to turn off an alarm signal transmitter in the event that it has been inadvertently initiated. Thus, if the system is actuating, operation of the manual switch may act to reset the system and, perhaps, to even transmit an “error” signal to indicate to the emergency centre 27 that the preceding actuation was accidental or that the accident is not of a severity requiring assistance.

The system of the present invention provides a unique advantage and overcomes operational difficulties of the prior art, having far greater coverage and superior likelihood of a timely response. Vehicles in remote areas may incorporate the inventive system as it is not necessary that the vehicle be in an area where, for example, mobile telephones are operable. The system may be incorporated in snowmobiles, working equipment in mines or the like, or any other vehicle that may be subject to accident involving life threatening circumstances. A further advantage is the cost of a system of the invention which is much reduced as neither by direction or communication facilities nor complex protocols are required.

1. An automatic emergency response system operable to notify an emergency center of a defined event and to facilitate location of the event, the system including signal generating means to generate a signal incorporating information which enables location of the signal to be established, an alarm signal transmitter operable on occurrence of a defined event to transmit an alarm signal incorporating said signal to a receiving station which provides the emergency center with information relating to the signal transmission, position determining means to establish its at least approximate location, a homing signal transmitter which simultaneously transmits a homing signal either continuously or at periodic intervals, and actuating means to initiate the alarm transmitter and homing signal transmitter, the actuating means being initiated by any of the defined events.

2. The system according to claim 1 wherein the signal generating means generates a coded signal to be transmitted by the alarm signal transmitter.

3. The system according to claim 1 wherein the position determining means comprises a GPS unit that provides position information to the signal generating means on a periodic basis.

4. A system according to claim 1 wherein the position determining means comprises satellites programmed to be able to detect the homing signals transmitted by the homing signal transmitter and to provide a relatively exact location of the transmitter.

5. The system according to claim 1 wherein the position determining means comprises a cellular telephone system network.

6. The system according to claim 1 wherein the defined event includes detected accident conditions.

7. The system according to claim 1 wherein the position determining means, the alarm signal transmitter, the beacon signal transmitter and actuating means are mounted in a vehicle.

8. The system according to claim 1 wherein an inbuilt battery is associated with the transmitters to provide power in the event the vehicle battery is disconnected or exhausted.

9. The system according to claim 1 wherein the actuating means comprises one or more accelerometers, smoke detectors, motion detector, air-bag actuator. seat belt retractor, or manual switch.

10. The system according to claim 1 wherein the alarm signal transmitted incorporates additional information including accident severity, vehicle identification, passenger numbers, vehicle attitude, and updated positional information if the vehicle is in motion.

11. The system according to claim 1 wherein the homing signal transmission is a radio beacon signal transmitted at regular intervals.

12. The system according to claim 11 wherein the radio beacon transmission includes GPS position location information.

13. The system according to claim 1 wherein the homing signal transmitter includes a strobe or other bright pulsing light, or other periodic light source, or sound source, to attract attention.

14. The system according to claim 1 wherein said signal generating means includes a control circuit operatively associated with the alarm signal transmitter and homing signal transmitter, the control circuit also monitoring battery charge and adjusts the frequency of transmission rates based on the monitored battery charge.

15. A system according to claim 1 wherein the alarm signal transmitter and homing signal transmitter are a single transmitter unit switched between operational modes as required.

16. An automatic emergency response system operable to notify an emergency center of a defined event and to facilitate location of the event, the system including position determining means to establish its at least approximate location, code generating means to generate a coded signal incorporating position location information, an alarm signal transmitter operable on occurrence of a defined event to transmit an alarm signal incorporating said coded signal to a receiving station which provides the emergency center with information relating to the signal transmission, including the positional information relating to the location of the transmitter, a relative low power homing signal transmitter which simultaneously transmits a homing signal either continuously or at periodic intervals, and actuating means to initiate the alarm transmitter and homing signal transmitter, the actuating means being initiated by any of the defined events.

17. The system according to claim 16 wherein the position determining means comprises a GPS unit that provides position information to the signal generating means on a periodic basis.

18. The system according to claim 16 wherein the position determining means comprises a cellular telephone system network.

19. The system according to claim 16 wherein the defined event includes detected accident conditions.

20. The system according to claim 16 wherein the position determining means, the alarm signal transmitter, the homing signal transmitter and actuating means are mounted in a vehicle.

21. The system according to claim 16 wherein an inbuilt battery is associated with the transmitters to provide power in the event the vehicle battery is disconnected or exhausted.

22. The system according to claim 16 wherein the actuating means comprises one or more accelerometers, smoke detectors, motion detector, air-bag actuator. seat belt retractor, or manual switch.

23. The system according to claim 16 wherein the coded alarm signal transmitted incorporates additional information including accident severity, vehicle identification, passenger numbers, vehicle attitude, and updated positional information if the vehicle is in motion.

24. The system according to claim 16 wherein the homing signal transmission is a radio beacon signal transmitted at regular intervals.

25. The system according to claim 24 wherein the radio beacon transmission included GPS position location information.

26. The system according to claim 16 wherein he homing signal transmitter includes a strobe or other bright pulsing light, or other periodic light source, or sound source, to attract attention.

27. The system according to claim 16 wherein said code generating means includes a control circuit operatively associated with the alarm signal transmitter and homing signal transmitter, the control circuit also monitoring battery charge and adjusts the frequency of transmission rates based on the monitored battery charge.

28. (canceled)
